(19) United States
(12) Patent Application Publication
(10) Pub. No.: US 2022/0030923 A1
(43) Pub. Date: Feb. 3, 2022

(54) Caffeine and Alpha Lipoic Acid Compositions for Enhanced Sensory Effects

(71) Applicants: Kristina Trigatti, Oakville (CA); Torrie Murphy, Oakville (CA); Vaishali Joshi, Oakville (CA); Tori van der Jagt, Oakville (CA); Victor Tenuta, Oakville (CA); Raza Bashir, Oakville (CA)

(72) Inventors: Kristina Trigatti, Oakville (CA); Torrie Murphy, Oakville (CA); Vaishali Joshi, Oakville (CA); Tori van der Jagt, Oakville (CA); Victor Tenuta, Oakville (CA); Raza Bashir, Oakville (CA)

(73) Assignee: Northern Innovations Holding Corp., Oakville (CA)

(21) Appl. No.: 17/378,745

(22) Filed: Jul. 18, 2021

Related U.S. Application Data
(60) Provisional application No. 63/053,077, filed on Jul. 17, 2020.

(51) Int. Cl. A23L 33/105

(52) U.S. Cl. CPC A23L 33/105

(57) ABSTRACT

A dietary supplement that comprises caffeine and alpha lipoic acid and optionally other compounds. The dietary supplement is useful for enhancing sensory effects for improvement of at least one of energy, focus, or productivity.

### FIELD OF THE INVENTION

The present invention relates generally to dietary supplements. More specifically, the present invention relates to compositions containing caffeine and alpha lipoic acid for enhanced sensory effects.

### BACKGROUND OF THE INVENTION

Caffeine blocks the inhibitory neurotransmitter adenosine, facilitating increases in stimulatory neurotransmitters including norepinephrine and dopamine. Caffeine ingestion results in improvements in general mental function including reaction times, memory, mood, and energy and can also boost metabolism to aid in fat burning. Furthermore, caffeine ingestion can increase muscle endurance, delaying fatigue. Caffeine has widespread use in dietary supplements for a range of indications most commonly weight loss products and pre-workout products.

As such, there is a need for improving the beneficial effects of caffeine-containing compositions by enhancing positive effects and/or reducing negative effects from consumption of such compositions.

### SUMMARY OF THE INVENTION

The present invention provides methods for enhancing the sensory effects of caffeine-containing dietary supplements. In an aspect of the invention, there is provided a method for enhancing sensory effects of caffeine-containing compositions by adding alpha lipoic acid to the caffeine-containing compositions.

In one embodiment, a method for enhancing sensory effects of dietary supplemental compositions containing from about 200 mg to about 300 mg caffeine and 200 mg alpha lipoic acid is provided.

In another embodiment, a method for enhancing sensory effects of dietary supplemental compositions containing from about 220 mg to about 290 mg caffeine and 200 mg alpha lipoic acid is provided.

In another embodiment, a method for enhancing sensory effects of dietary supplemental compositions containing 220 mg caffeine and 200 mg alpha lipoic acid is provided.

In another embodiment, a method for enhancing sensory effects of dietary supplemental compositions containing 290 mg caffeine and 200 mg alpha lipoic acid is provided.

In additional embodiments, the compositions further comprise additional compounds.

In certain embodiments, the composition comprises between 200 and 300 mg caffeine anhydrous; preferably between 220 and 290 mg caffeine anhydrous and about 200 mg alpha lipoic acid (ALA) and at least one of the following additional compounds: Mangifera indica extract, green coffee extract, Sage (Salvia officinalis), rosmarinic acid, huperzine, choline bitartrate (supplying choline), black pepper extract, Grains of Paradise and jujube.

In other embodiments, the compositions of the present invention additionally include at least one of the following ingredients in the following amounts: 50 to 150 mg, preferably 100 mg Mangifera indica extract; 150 to 250 mg, preferably 200 mg green coffee extract; 30 to 70 mg, preferably 50 mg Sage (Salvia officinalis); 5 to 15 mcg, preferably 10 mcg huperzine; 200 to 300 mg, preferably 249 mg choline bitartrate (supplying 100 mg choline), 3 to 8 mg, preferably 5.3 mg black pepper extract, 10 to 30 mg, preferably 20 mg Grains of Paradise, 25 to 75 mg, preferably 50 mg jujube.

### DETAILED DESCRIPTION OF THE EMBODIMENTS

The above-described embodiments are intended to be examples of the present invention and alterations and modifications may be affected thereto, by those of skill in the art. The scope of the claims should not be limited by the preferred embodiments set forth in the examples but should be given the broadest interpretation consistent with the description as a whole.

During development and testing of compositions for weight loss, the inventors identified combinations that produced unexpected, enhanced sensory effects in individuals consuming said compositions. As used herein, “sensory effects” are defined as user-perceived changes associated with beneficial, improved physiological or mental processes. Although there is a degree of subjectivity to perceived improved physiological or mental processes, the direction and magnitude of changes in such self-perceived effects are expected to be reasonably indicative of the sensory effects of such compositions. As used herein, “sensory effects” includes such effects as feeling increased focus, energy, and productivity, as well as clarity, thermogenesis, or warmth. As used herein, “sensory effects” do not solely include such effects as those directly related to the basic senses such as taste, touch. or smell.

Previous formulations intended for weight loss had been produced using several ingredients and examined. The inventors unexpectedly found that a combination of two ingredients—caffeine and alpha lipoic acid (ALA) produced unexpected sensory effects. To evaluate the potential synergistic effects of these ingredients, 1 serving (2 powder capsules) were created containing 220 mg caffeine and 200 mg ALA along with several other ingredients and administered among 10 participants who were instructed to take the capsules before working out or working at their desk. Sensory questionnaires were distributed with the capsules, and participants were instructed to provide a rating (out of 10) for perceived Energy, Focus, and Productivity and provide their comments on the overall effectiveness of the product. Representative samples for eighteen rounds are shown in Example 1 below. Once the sensory evaluation was completed, questionnaires were collected, and average results were calculated to provide overall ratings and feedback of the product. Results for samples of Example 1 are shown in Table 1. The same sensory evaluation was replicated using a different ingredient to replace the ALA as an experimental exercise to test additional ingredients combined with caffeine. Overall, it was determined that the ALA and caffeine combination unexpectedly performed better among participants as this combination received higher ratings across all categories. As a result of three sensory evaluations over a period 2 weeks, it was concluded that 200 mg of ALA in combination with between 200 and 300 mg of caffeine led to a stronger positive sensory effect and contributed to the overall energy and focus experience of the formula.

### Example 1

Round 1. 150 mg caffeine, 100 mg methylliberine 40%, 50 mg theacrine 40%.
Round 2. 275 mg caffeine, 75 mg methylliberine 40%, 75 mg theacrine 40%.
Round 3. 275 mg caffeine, 50 mg methylliberine 40%, 75 mg theacrine 40%.
Round 4. 275 mg caffeine, 75 mg methylliberine 40%, 75 mg theacrine 40%, 20 mg Yohimbe.
Round 5 (repeat of Round 4). 275 mg caffeine, 75 mg methylliberine 40%, 75 mg theacrine 40%, 20 mg Yohimbe.
Round 6. 275 mg caffeine, 100 mg methylliberine 40%, 50 mg theacrine 40%.
Round 7. 275 mg caffeine, 75 mg methylliberine 40%, 75 mg theacrine 40%.
Round 8. 220 mg caffeine.
Round 9. 290 mg caffeine, 100 mg Coleus forskohlii extract (10% forskolin), 200 mg green coffee extract (45% chlorogenic acid), 200 mg green coffee extract (5% chlorogenic acid), 40 mg Yohimbe bark extract powder (6% yohimbine), 75 mg Scutellaria baicalensis extract (30% baicalin), 25 mg Radix ophiopogonis extract, 20 mg Guayusa.
Round 10. 290 mg caffeine, 200 mg green coffee extract (45% chlorogenic acid), 100 mg fennel, 100 mg black ginger root, 40 mg Grains of Paradise, 30 mg Yohimbe.
Round 11. 290 mg caffeine, 200 mg green coffee extract (45% chlorogenic acid), 100 mg fennel, 100 mg black ginger root, 40 mg Grains of Paradise, 30 mg Yohimbe, 75 mg methylliberine 40%.
Round 12. Commercial weight loss and energy product: proprietary blend having caffeine, cayenne extract, black pepper extract (no ALA).
Round 13. 220 mg caffeine, 50 mg Mangifera indica extract.
Round 14. 220 mg caffeine, 100 mg Mangifera indica extract.
Round 15. 290 mg caffeine, 75 mg methylliberine 40%, 75 mg Mangifera indica extract, 200 mg green coffee extract (45% chlorogenic acid), 75 mg black caraway, 75 mg black ginger root, 50 mg sage, 10 mcg huperzine, 100 mg choline, 53 mg black pepper extract, 20 mg Grains of Paradise, 50 mg jujube.
Round 16. 220 mg caffeine, 150 mg curcumin, 53 mg black pepper extract.
Round 17. 220 mg caffeine, 200 mg ALA, 5.3 mg black pepper extract.
Round 18. 290 mg caffeine anhydrous, 100 mg Mangifera indica extract, 200 mg ALA, 200 mg green coffee extract, 50 mg Sage (Salvia officinalis) std. 2.5% rosmarinic acid, 10 mcg huperzine, 249 mg choline bitartrate (supplying 100 mg choline), 5.3 mg black pepper extract, 20 mg Grains of Paradise, 50 mg jujube.

TABLE 1

| | Energy | | Productivity |
|---|---|---|---|
| Sample | Rating | Focus Rating | Rating |
| Round 1 | 7.4 | 7.9 | 7.7 |
| Round 2 | 8.1 | 8 | 8 |
| Round 3 | 6.4 | 6.6 | 6.6 |
| Round 4 | 6.2 | 6.2 | 7.0 |
| Round 5 | 6.7 | 6.6 | 6.9 |
| Round 6 | 7.4 | 7.6 | 7.8 |
| Round 7 | 7.1 | 7.0 | 6.8 |
| Round 8 | 7.3 | 7.1 | 7.3 |
| Round 9 | 7.9 | 7.4 | 8.2 |
| Round 10 | 7.4 | 7.2 | 7.2 |
| Round 11 | 7.4 | 7.4 | 7.5 |
| Round 12 | 6.6 | 7.3 | 7.5 |
| Round 13 | 7.1 | 7.1 | 7.1 |
| Round 14 | 7.7 | 7.6 | 8.1 |
| Round 15 | 7.3 | 7.1 | 7.5 |
| Round 16 | 7.2 | 7.3 | 7.3 |
| Round 17 | 7.3 | 7.8 | 7.5 |
| Round 18 | 8.4 | 8.1 | 8.1 |

The compositions may be administered by any of the commonly known routes, such as, but not limited to, incorporation into foods or beverages or in supplemental forms such as powders, liquids, tablets, caplets, capsules or gel caps.

The above-described embodiments are intended to be examples of the present invention and upon reading of the specification, alterations and modifications that may be effected thereto will be recognized by those of skill in the art. The scope of the claims should not be limited by the preferred embodiments set forth in the examples, but should be given the broadest interpretation consistent with the description as a whole, as understood by those of skill in the art.

What is claimed is:

1. A method of supplementation for enhancing sensory effects resultant from consumption of a caffeine-containing dietary supplement comprising; administering to an individual desirous of enhanced sensory effects, a composition comprising caffeine and alpha lipoic acid, wherein the caffeine and the alpha lipoic acid in the composition are in amounts that produce enhanced sensory effects.

2. The method of claim 1, wherein the composition comprises from about 200 mg to about 300 mg caffeine and 200 mg alpha lipoic acid.

3. The method of claim 1, wherein the composition comprises 220 mg caffeine and 200 mg alpha lipoic acid.

4. The method of claim 1, wherein the composition comprises 290 mg caffeine and 200 mg alpha lipoic acid.

5. The method of claim 2, further comprising at least one of Mangifera indica extract, green coffee extract, Sage (Salvia officinalis), huperzine, choline, black pepper extract, Grains of Paradise, and jujube.

6. The method of claim 3, further comprising at least one of Mangifera indica extract, green coffee extract, Sage (Salvia officinalis), huperzine, choline, black pepper extract, Grains of Paradise, and jujube.

7. The method of claim 4, further comprising at least one of Mangifera indica extract, green coffee extract, Sage (Salvia officinalis), huperzine, choline, black pepper extract, Grains of Paradise, and jujube.

8. The method of claim 5, further comprising 50 to 150 mg Mangifera indica extract; 150 to 250 mg green coffee extract; 30 to 70 mg Sage (Salvia officinalis); 5 to 15 mcg huperzine; 200 to 300 mg choline bitartrate, 3 to 8 mg black pepper extract, 10 to 30 mg Grains of Paradise, and 25 to 75 mg jujube.

9. The method of claim 6, further comprising 50 to 150 mg Mangifera indica extract; 150 to 250 mg green coffee extract; 30 to 70 mg Sage (Salvia officinalis); 5 to 15 mcg huperzine; 200 to 300 mg choline bitartrate, 3 to 8 mg black pepper extract, 10 to 30 mg Grains of Paradise, and 25 to 75 mg jujube.

10. The method of claim 7, further comprising 50 to 150 mg Mangifera indica extract; 150 to 250 mg green coffee extract; 30 to 70 mg Sage (Salvia officinalis); 5 to 15 mcg huperzine; 200 to 300 mg choline bitartrate, 3 to 8 mg black pepper extract, 10 to 30 mg Grains of Paradise, and 25 to 75 mg jujube.

11. The method of claim 5, further comprising 100 mg Mangifera indica extract; 200 mg green coffee extract; 50 mg Sage (Salvia officinalis); 10 mcg huperzine; 249 mg choline bitartrate (supplying 100 mg choline), 5.3 mg black pepper extract, 20 mg Grains of Paradise and 50 mg jujube.

12. The method of claim 6, further comprising 100 mg Mangifera indica extract; 200 mg green coffee extract; 50 mg Sage (Salvia officinalis); 10 mcg huperzine; 249 mg choline bitartrate (supplying 100 mg choline), 5.3 mg black pepper extract, 20 mg Grains of Paradise and 50 mg jujube.

13. The method of claim 7, further comprising 100 mg Mangifera indica extract; 200 mg green coffee extract; 50 mg Sage (Salvia officinalis); 10 mcg huperzine; 249 mg choline bitartrate (supplying 100 mg choline), 5.3 mg black pepper extract, 20 mg Grains of Paradise and 50 mg jujube.
